(19) United States
(12) Patent Application Publication
(10) Pub. No.: US 2007/0090992 A1
(43) Pub. Date: Apr. 26, 2007

(54) Radar level gauge system and transmission line probe for use in such a system

(76) Inventor: Olov Edvardsson, Linkoping (SE)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/256,039

(22) Filed: Oct. 21, 2005

(51) Int. Cl. G01S 13/08

(52) U.S. Cl. 342/124; 342/175

(57) ABSTRACT

A radar level gauge system, for measuring a filling level of a content contained in a tank, said radar level gauge system comprising a transmitter arranged outside said tank and configured to transmit microwave energy, a receiver arranged outside said tank and configured to receive reflected microwave energy, and a transmission line probe, comprising at least one probe line, configured to guide transmitted microwave energy towards and from said content, said probe at least partly disposed inside said tank, wherein said transmission line probe further comprises a dielectric enclosing structure enclosing at least a substantial part of said at least one probe line, wherein said dielectric enclosing structure is arranged to reduce the microwave energy attenuating effect caused by said content to be gauged. An advantage with the above system is its improved accuracy when measuring a filling level of a content contained in a tank, as the attenuation introduced by the content is reduced by the dicloctric enclosing structure.

### TECHNICAL FIELD OF THE INVENTION

The present invention relates to a radar level gauge system for measuring a filling level of a content contained in a tank. The invention further relates to a transmission line probe for use in such a system.

### BACKGROUND OF THE INVENTION

The process control and the transport industry employs process parameter gauges to monitor process parameters associated with substances such as solids, liquids and gasses in industries directed to chemicals, petroleum, pharmaceuticals, food, etc. Process parameters include pressure, temperature, flow, level, chemical composition and other properties. For measuring level of material contained in tanks, radar level gauge systems are often used. These systems normally employ a transmitter to transmit microwave energy, a receiver to receive a reflected fraction of said transmitted microwave energy, and a controller to evaluate the distance from the radar echo. In many cases a narrow beam antenna directed towards the surface is used (“non contacting radar”), but depending on the structure and design of the tank, and depending on the material deposited inside of the tank, a transmission line probe can be used. The transmission line radar is referred to as “contacting radar” or “guided wave radar” (GWR) and is one way to avoid the problem that the radar echoes from the surface may be disturbed by an echo from various obstacles in the tank.

The use of transmission line probes is especially suitable when measuring an interface level between two materials (such as air and oil).

To this end, it is possible to use a two-wire transmission line probe, a slightly perforated coaxial line or a single wire surface waveguide. Practical constraints determine when different types of transmission lines are used and for instance a coaxial line can only be used in very clean liquids, as there is no control over accumulation of deposit inside the tube. When the (generally vertical) transmission passes the liquid surface or the interface between two liquids there is a change of the properties of the transmission line due to the dielectric constant of the material around the line. A radar wave propagating along the line will be partly reflected at the interface and that reflection is useable by a radar level gauge connected to the line for estimation of the level.

U.S. Pat. No. 6,085,589 discloses such a system for measuring a level of material in a vessel that includes a transmission line probe adapted to be positioned for contact with material in the vessel. Electronic components are coupled to the transmission line probe for launching microwave radiation along the probe and detecting radiation reflected by the electrical impedance discontinuity presented at the air/material interface in the vessel The level of the air/material interface within the vessel is determined employing time domain reflectometry (TDR) techniques. According to one embodiment of this disclosed system, a transmission line probe that includes parallel probe lines is described, wherein the parallel probe lines are separated from each other by a dielectric spacer. This allows for adequate separation and parallel alignment of the probe lines.

However, there are problem with this and other similar systems disclosed in the prior art that uses parallel probe lines as they tend to provide insufficient accuracy of measurement, e.g. when measuring two interface levels between three materials (e.g. air/oil/water). Some tank atmospheres, for instance ammonium under pressure, are known to attenuate the radar signal during its passage down to the surface. A typical problem in such cases is e.g. that the upper liquid introduces an attenuation, which makes the interface echo too weak when the radar has to pass through a thick layer of the upper liquid. Furthermore, prior art systems using transmission line probes tends to have problems with corrosion due to the content contained in the tank.

It is therefore an object of the present invention to provide an improved transmission line probe that provides a solution to at least some of the above-mentioned problems.

### SUMMARY OF THE INVENTION

This object is achieved by means of a radar level gauge system for measuring a filling level of a content contained in a tank and a transmission line probe as defined in the appended claims. The appended sub-claims define advantageous embodiments in accordance with the present invention.

According to a first aspect of the present invention, there is provided a radar level gauge system, for measuring a filling level of a content contained in a tank, said radar level gauge system comprising a transmitter configured to transmit microwave energy, a receiver arranged outside said tank and configured to receive reflected microwave energy, and a transmission line probe, comprising at least one probe line, configured to guide transmitted microwave energy towards and from said content, said transmission line probe at least partly disposed inside said tank, wherein said transmission line probe further comprises a dielectric enclosing structure enclosing at least a substantial part of said at least one probe line, wherein said dielectric enclosing structure has a thickness arranged to reduce the microwave energy attenuating effect caused by said content to be gauged. An advantage with the above system is its improved accuracy when measuring a filling level of a content contained in a tank, as the attenuation introduced by the content is reduced by the dielectric enclosing structure. The attenuation through said dielectric material will be reduced by the invention and the same will apply in case the atmosphere has big attenuation. Hereby, accurate measurements are rendered possible even in cases where the transmission line probe extends through a dielectric environment, and where a level to be measured is situated below a layer of dielectric material. The expression “enclosing at least a substantial part of said at least one probe line” is understood to mean that a significant part of the area of the active part of probe is enclosed. Preferably the part of the transmission line probe that is inserted in the tank is essentially corn pletely enclosed, or at least that part of the transmission line probe that is to be in contact with the content contained in the tank. Preferably, the active part of the transmission line probe is also substantially or completely enclosed in a axial direction. In addition, the dielectric enclosing structure also provides a protective shield for the at least one transmissive probe line, and thereby protects the at least one line for corrosion and the like caused by the content in the tank. In one embodiment, the transmission line probe comprises parallel probe lines, wherein at least a substantial part of said parallel probe lines are enclosed by said dielectric enclosing structure. However, alternatives are possible, such as in a case where for example a first probe line is constituted by an enclosed probe line as described above, and a second probe line is constituted by for example the tank wall ox an angle bar.

In particular, the present invention is useful for determining reflections from several levels simultaneously. In such a case, the system is preferably arranged to receive reflections from at least two material interfaces inside said tank. An advantage with this is that it becomes possible to accurately measure several levels, when e.g. the tank is filled with a multilayered substance, and thus to measure even the level of a second content closest to the bottom of the tank. In one case, where the content to be gauged consists of oil, and the content closes to the bottom consists of water, it would be possible with a system according to this embodiment to compensate for the bottom content (water) and hence provide an even more accurate measurement of the “real” content to be gauged (oil). In another embodiment, it is provided a radar level gauge system wherein said dielectric enclosing structure comprises an outer surface forming an outer surface of said transmission line probe, and an inner surface arranged at a distance from said at least one probe line. Preferably, the distance (D) from an outer surface of said dielectrically enclosed transmission line probe to an outer surface of said at least one probe line is greater than half the radius (R) of said at least one probe line, more preferably greater than the radius (R) of said at least one probe line, and even more preferably greater than two times the radius (R) of said at least one probe line. By radius is in this context to be understood not only an ordinary radius for a probe line with a circular cross-section, but also the smallest distance between a center point and the outer boundary in case of other, non-circular cross-sections With the above-discussed thicknesses, the above-discussed dielectric enclosing structure provides for a very effecLive reduction of the microwave energy attenuating effect caused by the content to be gauged. As understood by the person skilled in the art, this embodiment of the present invention also provides for an even lower corrosive impact caused by the content in the tank. A possible implementation of this embodiment is by placing the at least one probe line inside for example a plastic tube In this case, both the pipe and the volume between the pipe and the at least one probe line will be part of the dielectric enclosing structure, and provide for a smaller microwave energy attenuating effect caused.by the content to be gauged.

The volume between the pipe and the at least one probe line may be filled with a gas, such as ambient air. However, in a preferred embodiment, the volume between said inner surface of said dielectrically enclosing structure and said at least one probe line is at least partly filled with a solid dielectric filling material. A thick plastic enclosure is one straightforward possibility, but alternatively, the solid dielectric filling material could be selected from crystalline and amorphous materials, such as a ceramic or glass. This embodiment will have a lower propagation velocity, and have the advantage of an even smaller microwave energy attenuating effect caused by the content to be gauged.

The transmission line probe of the present invention may be regarded as a Partially External Dielectric (PED) transmission line probe. The FED-transmission line probe according to the present invention is formed by said transmission line probe enclosed by said dielectric enclosing structure arranged in said tank.

The propagation velocity along the transmission line is characterized by an efficient dielectric constant ∈_{eff} which is a kind of average between the dielectric constant of the insulation in line itself (which may be more than one material) εᵢₙₜ and the dielectric.constant of the surrounding medium (air, oil etc.) ∈ₑₓₜ. The propagation velocity is the velocity of light divided by the square root of ∈_{eff} and is crucial to know for the distance measurement. The typical feature of the PED-transmission line is that the ∈_{eff} depends both on the line itself (∈ᵢₙₜ) and the surrounding medium (∈ₑₓₜ).

The degree of insulation provided by the dielectric enclosing structure and the surrounding material may be characterized by means of an “insulation factor” α which is the relative derivative for ∈_{eff}, as a function of ∈ₑₓₜ. The insulation factor α is essentially:

$$α = \frac{{ɛ}_{ext} Δ {ɛ}_{eff}}{{ɛ}_{eff} Δ {ɛ}_{ext}}$$

An inspection of α=0 implies that there is no influence of the external dielectric which is the normal case for coaxial cables etc. which can be installed anywhere without influence of the surroundings, and that α=1 or very close to 1 is transmission lines used by prior art radar level gauges (i.e. essentially naked lines, possibly with a protective layer of PTFE, etc.). If the derivative is evaluated as differences it is most suitable to see α as the variation of ∈_{eff} when ∈ₑₓₜ changes from 2 to 3, which include most kind of oils. The insulation factor α has a rather slow dependence of ∈ₑₓₜ so the choice of ∈ₑₓₜ, to characterize α is not critical, and typically α is close to its maximum value when the surrounding medium has a low dielectric constant like 1-3. To find α from laboratory measurements, ∈_{eff} is closely related the capacitance between the lines in case of a two-conductor line and in the formula Ε_{eff} can be exchanged to the capacitance.

The proposed system uses preferably uses an intermediate value, such as 0.2≦α≦0.8 and more preferably 0.2≦α≦0.5, to give a possibility to decrease the attenuation of the upper layer, while preserving the reflection of the lower interface, which is still possible to measure Hereby, the reflection of a lower level interface will decrease, but since the attenuation through the material of the higher layer is increasing with the thickness, the interface reflection is independent of the thickness so there will be a substantial improvement of the possibility to measure through a thick layer. As understood by the person skilled in the art in light of the above discussion, this provides for an improved way of measuring e.g. the two interface levels between three materials (e.g. air/oil/water). It is also a method to reduce the attenuation of certain gasses in the tank atmosphere.

To illustrate the influence of the insulation factor α, two calculated examples are shown in FIG. 5a and 5b. The radar level gauge is represented by the frequency 0.5 GHz (corresponding to a pulse length of 1 ns) Furthermore, the upper layer has an dielectric constant, ∈, of 2.5 with a loss factor of 0.05 and 0.02 in FIG. 5a and 5b respectively. For three different thicknesses of the upper layer (12.8 m, 5.3 m and 0.2 m), the sum of the dielectric attenuation through the liquid and the reflection attenuation at the interface has been calculated. If the used radar system has a capability of measure when the sum of these two attenuations are below 40 dB, the curves in FIG. 5a shows that measurement is possible through 0-5.3 meter of oil, expect for very small values of the insulation factor (α), and especially for the prior art choice of α=1. Thicker layer measurement at α˜1 is not possible but with an optimal value of the insulation factor (in this case 0.15) measurements are possible up to 12.8 m thick oil layers. For a smaller loss factor in the liquid (0.02), the curves are slightly changed as can be seen in FIG. 5b. In this figure the same distances are used, as in FIG. 5a, and now all three distances (i.e. up to 12.8 m) can be measured by the prior art choice of α˜1, but the attenuation can be decreased approximately five times (in power) by using an optimal value of α. In a practical installation the maximum occurring loss factor can be used to choose the optimal insulation factor, as all lower loss factors will give less attenuation.

According to a further aspect of the present invention there is provided a transmission line probe, for use in a radar level gauge system arranged to measure a filling level of a content contained in a tank, wherein said transmission line probe comprises at least one probe line configured to guide transmitted microwave energy towards and from said content, and a dielectric structure essentially enclosing said at least one probe line, wherein said enclosing structure is arranged to reduce the microwave energy attenuating effect caused by said content to be gauged. As described above in relation to the first aspect of the present invention, this novel transmission line probe provides a plurality of advantages such as for example improved accuracy when measuring a filling level of a content contained in a tank, as the attenuation introduced by the content is reduced by the dielectric enclosing structure. Furthermore, the transmission line probe according to the present invention makes it possible to in an more accurate manner measure the level of the content closest to the bottom of the tank.

Further features and advantages of the present invention will become apparent when studying the appended claims and the following description. Those skilled in the art will appreciate that different features of the present invention can be combined in other ways to create embodiments other than those described in the following.

### BRIEF DESCRIPTION OF THE DRAWINGS

By way of example, the present invention will now be described in more detail with reference to the accompanying drawings, in which:

FIG. 1 illustrates a radar level gauge system according to the present invention, installed onto a tank system;

FIG. 2 illustrates a detailed view of a radar level gauge system according to the present invention;

FIG. 3 illustrates examples of transmission line probes preferably used in a radar level gauge system according to the present invention; and

FIG. 4 illustrates, in two separate diagrams, reflected signals from material interfaces according to prior art and the present invention respectively.

FIG. 5 illustrates two diagrams showing the attenuation for different the insulation factor α for some exemplary thicknesses of the dielectric enclosing structure.

### DETAILED DESCRIPTION OF THE EMBODIMENTS

In the present description, like reference numerals identify corresponding or similar structures and components.

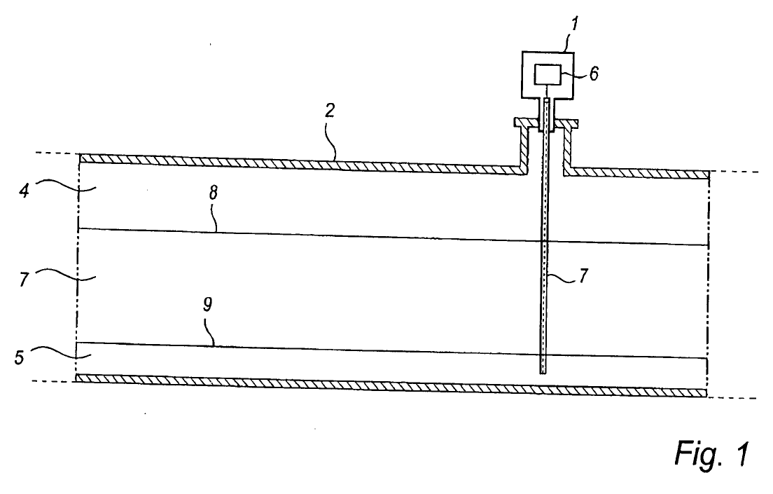

In FIG. 1, an example of a radar level gauge system according to the present invention is shown. Here, a radar level gauge system 1 has been installed onto a tank 2. Inside of the tank 2, content 3 has been deposited, such as oil. When the tank 2 is not completely full, the top part of the tank will comprise a layer of gas, and typically air 4. A small amount of water is often present in a tank (due to condensation), and this layer of water 5 can be seen on the bottom of tank 2. However, it is to be appreciated by the skilled addressee that the present radar level gauge system may be used for many other types of tanks and containers, and for many other types of filling materials.

The radar level gauge system 1 further comprises a transmitter and a receiver, and preferably a transceiver 6 consisting of a combined transmitter and receiver, arranged to transmit and receive microwave energy. Furthermore, the system comprises a transmission line probe 7, configured to guide transmitted microwave energy towards and from the content in the tank 2. The transmission line probe 7 extends vertically from the radar level gauge system 1 towards the bottom of the tank 2, and will thereby be at least partly in contact with both the oil content 3 and the water content 5 inside the tank 2.

During a measurement procedure, pulsed microwave energy will be transmitted from the transmitter part of transceiver 6 through the transmission line probe 7, whereby a first and second reflection caused by each of the content interfaces 8 (air/oil) and 9 (oil/water) will be transmitted back through the transmission line probe 7 to the receiver part of transceiver 6. A controller employing time domain reflectometry (TDR) techniques will be used to analyze the time from when the microwave energy was transmitted to when the reflections were received, whereby a distance to the first and second content interfaces 8 and 9 can be calculated. By subtracting the distance from the bottom of the tank to the second interfaces 9 from the distance from the bottom of the tank to the first interfaces 8, an accurate measurement level representing the level of “real content” (oil) can be provided. However, it will be appreciated by the skilled addressee that the herein described transmission line probes and radar level gauge system may also be used for other types of per se well-known measurement procedures. For example, other pulsed measurement procedures than TDR may be used, or continuously emitted microwave energy, such as in FMCW. The functional description above uses air/oil/water as examples and it should be noted that with an insulation factor α well below 1 it is possible to measure a bottom echo through the water and measure an accurate bottom echo. This possibility increases the accuracy as a prior art probe normally hides the bottom echo through the water, which is next to opaque for radar.

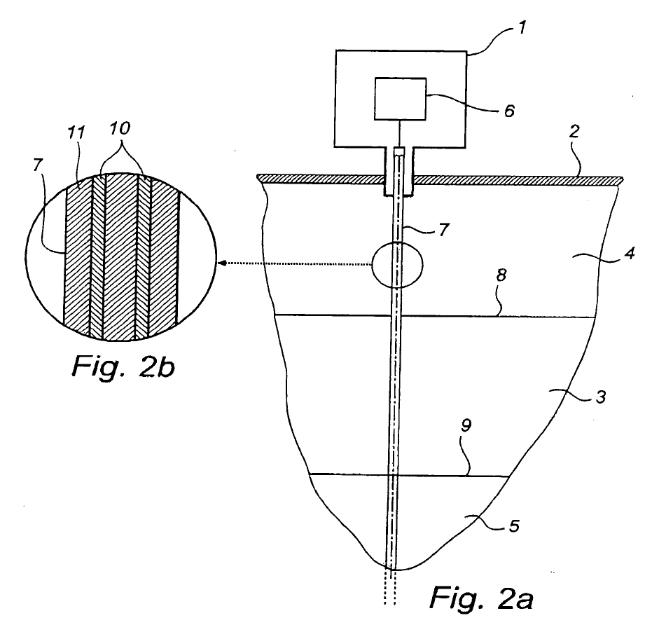

In FIG. 2a a detailed view of the radar level gauge system 1 illustrated in FIG. 1 is shown. As in FIG. 1, the radar level system 1 has been installed onto a tank 2 (where the top of the tank can be seen), further comprising a transceiver 6 and a transmission line probe 7. The transmission line probe is vertically installed in the tank 2, and is at least partly in contact with the tank contents 3, 4 and 5. Furthermore, the first 8 and the second 9 interface levels (air/oil and oil/water) can be seen.

FIG. 2b shows a detailed section view of the vertically stretching transmission line probe 7 from FIG. 2a. The transmission line probe 7 comprises parallel probe lines 10 and a dielectric enclosing structure 11, where the dielectric enclosing structure 11 is arranged to reduce the microwave energy attenuating effect caused by said content to be gauged, and to protect the probe lines from corrosion and the like.

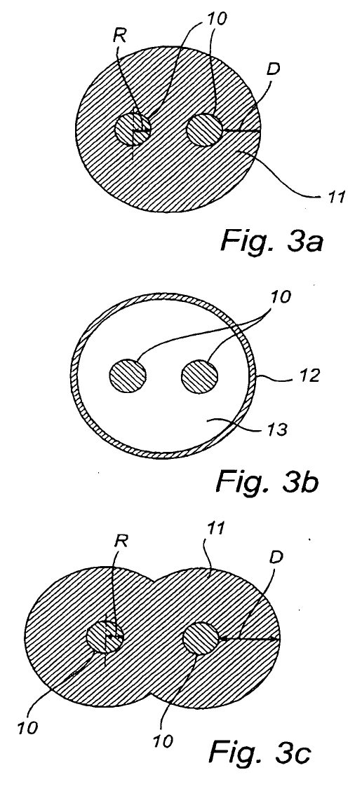

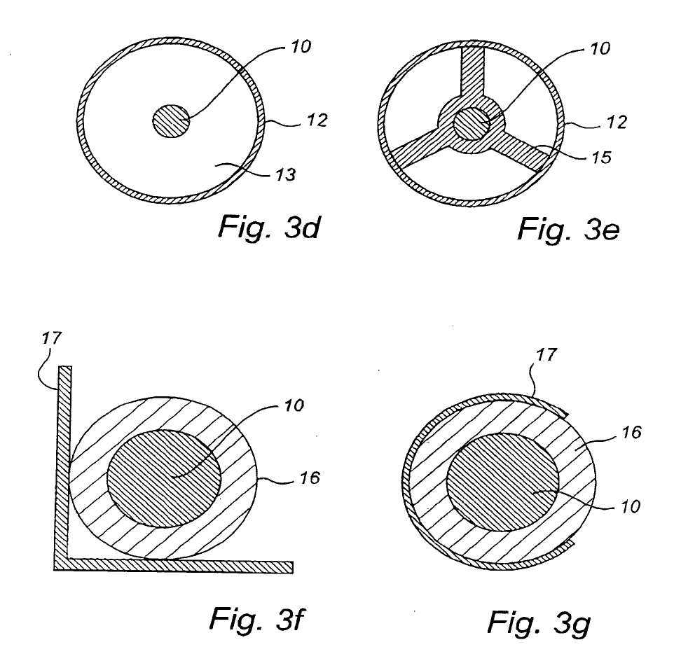

FIG. 3a is a radial cross-section view of a transmission line probe 7 according to the present invention In this embodiment, the probe lines 10 are enclosed by a dielectric structure 11. The distance D from the outer surface of the dielectrically enclosed transmission line probe 7 to the outer surface of each of the parallel probe lines 10 is greater than the radius R of each of the parallel probe lines. This provides for a transmission line probe 7 with effective resistance against corrosion, with improved measurement performance. FIG. 3b is a radial cross-section view of a transmission line probe 7 according to another embodiment of the present invention. In this embodiment, the probe lines 10 are positioned inside a plastic tube 12, serving as an outer structural enclosure of the probe lines 10. The volume 13 between the inner surface of the structure enclosing tube 12 can either consist of a gas, such as air, or be at least partly filled by a solid or liquid dielectric filling material In the case where the volume 1.3 is filled with a solid dielectric filling material, it can preferably be selected from crystalline and/or amorphous materials, such as a ceramic or glass.

FIG. 3c is also a radial cross-section view of a transmission line probe 7 according to still another embodiment of the present invention. In this embodiment, the distance D, from the outer surface of the dielectrically enclosed transmission line probe 7 to the outer surface of each of the parallel probe lines 10, is equal at any point around the outer surface of the dielectrically enclosed transmission line probe 7. This embodiment provides for a transmission line probe 7 where the systems total dialectical constant can be more casier calculated as the microwave energy attenuating effect caused by the content to be gauged will be equal at any point around the outer surface of the dielectrically enclosed transmission line probe 7.

FIG. 3d is also a radial cross-section view of a transmission line probe 7 according to still yet another embodiment of the present invention. In this case, a single line probe line 10 is positioned inside a plastic tube 12, serving as an outer structural enclosure of the probe line 10. The volume 13 between the inner surface of the structure enclosing tube 12 can either consist of a gas, such as air, or be at least partly filled by a solid or liquid dielectric filling material.

FIG. 3e illustrates, in the same way as FIG. 3d, a single probe line 10 positioned inside a plastic tube 12. In this embodiment, a centerpiece 15 holds the probe line 10 centered inside the tube 12.

In FIG. 3f, a single probe line 10 is covered by a insulating material 16. The insulated probe line 10 is furthermore arranged onto, as an example, an angle bar 17. In this case, a metallic ribbon or the angle bar 17 serves as a second conductor, In another case, the wall of the tank can serve as the second conductor instead of the angle bar 17.

In a similar manner, FIG. 3g illustrates a single line probe line 10 covered by a insulating material 16. A metallic covering 17 encloses approximately 60 to 80% of the probe line 10. As in FIG. 3f, the metallic covering 17 serves as a second conductor.

The combination of a single line probe and a second conductor will act parallel probe lines, as described above. In this case, the parallel probe lines will be asymmetrically arranged.

Furthermore, the use of an insulated single line probe will allow for new selection of conductive material for the protected conductor. Preferably copper is selected as conductor.

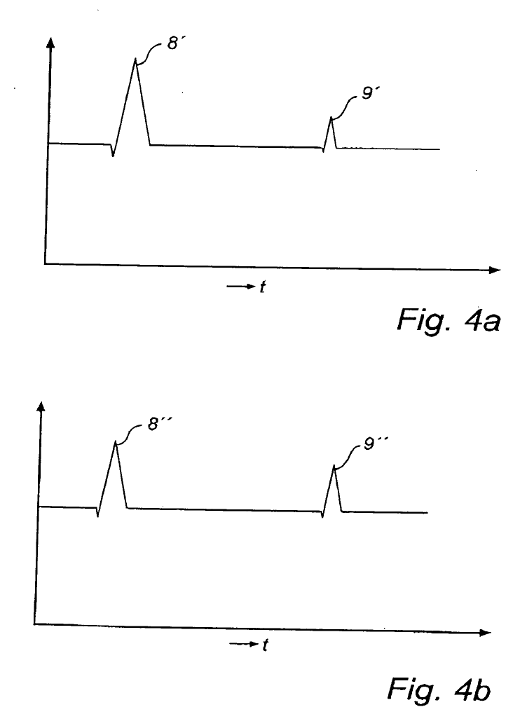

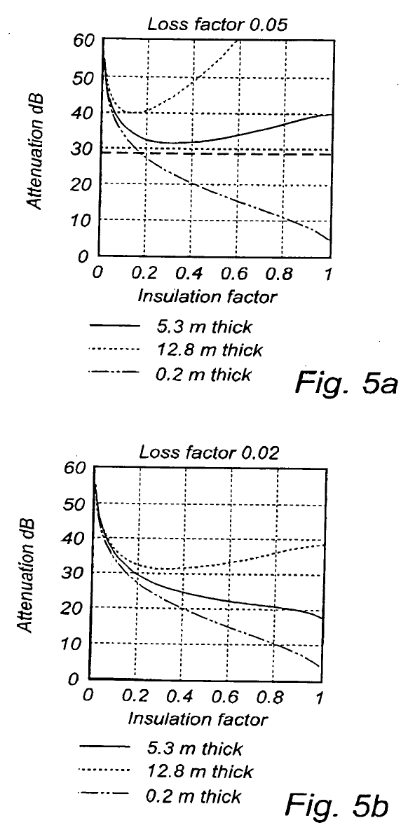

FIG. 4a schematically illustrates reflected signal peaks 8′ and 9′ from two material interfaces 8 and 9 (as shown in FIG. 2a), according to prior art. As can be seen, the reflected signal 9′ is attenuated due to the dielectric influence from the content to be gauged.

In FIG. 4b, the same reflected signal peaks as in FIG. 4a is schematically illustrated, but here a dielectrically enclosed transmission line probe according to the present invention is used. In the same manner as in FIG. 4a, reflected signal peaks 8″ and 9″ from two material interfaces 8 and 9 are present. In this embodiment, the enclosing structure will introduce a small attenuation effect on peak 8″, while causing the microwave energy attenuating effect attenuating peak 9″ to be lower, hence producing a larger peak interface reflection from the bottom material.

The person skilled in the art realizes that many variations and alternatives to the above-discussed detailed embodiments of the present invention are possible, and that the invention by no means is limited to the preferred embodiments described above. On the contrary, many modifications and variations are possible within the scope of the appended claims. For example, the transmission line probe as outlined may be used in essentially all available types of radar level gauging. Further, the enclosing dielectric cover may be realized in many different ways, using e.g. different thicknesses, different dielectric materials, etc. Still further, the transmission line probe may have more than two probe lines, such as four or six lines.

1. A radar level gauge system, for measuring a filling level of a content contained in a tank, said radar level gauge system comprising:
a transmitter configured to transmit microwave energy;
a receiver arranged outside said tank and configured to receive reflected microwave energy; and
a transmission line probe, comprising at least one probe line, configured to guide transmitted microwave energy towards and from said content, said probe at least partly disposed inside said tank,
wherein said transmission line probe further comprises a dielectric enclosing structure enclosing at least a substantial part of said at least one probe line, wherein said dielectric enclosing structure has a thickness arranged to reduce the microwave energy attenuating effect caused by said content to be gauged.

2. A radar level gauge system according to claim 1, wherein said transmission line probe comprises parallel probe lines, wherein at least a substantial part of said parallel probe lines are enclosed by said dielectric enclosing structure.

3. A radar level gauge system according to claim 1, wherein said transmission line probe enclosed by said dielectric enclosing structure arranged in said tank is a Partially External Dielectric (PED) transmission line probe.

4. A radar level gauge system according to claim 1, wherein said dielectric enclosing structure provides an insulation factor α which is greater than or equal to 0.2 and smaller than or equal to 0.8.

5. A radar level gauge system according to claim 1, wherein said dielectric enclosing structure provides an insulation factor α which is greater than or equal to 0.2 and smaller than or equal to 0.5.

6. A radar level gauge system according to claim 1, wherein system is arranged to receive reflections from at least two material interfaces inside said tank.

7. A radar level gauge system according to claim 1, wherein said dielectric enclosing structure comprises an outer surface forming an outer surface of said transmission line probe, and an inner surface arranged at a distance from said at least one probe line.

8. A radar level gauge system according to claim 1, wherein a distance (D) from an outer surface of said probe line with a dielectric enclosing structure to an outer surface of said probe line is greater than half a radius (R)) of said probe line.

9. A radar level gauge system according to claim 1, wherein a distance (D) from an outer surface of said probe line with a dielectric enclosing structure to an outer surface of said probe line is greater than a radius (R) of said probe line.

10. A radar level gauge system according to claim 1, wherein a distance (D) from an outer surface of said probe line with a dielectric enclosing structure to an outer surface of said probe line is greater than two times a radius (R) of said probe line.

11. A radar level gauge system according to claim 1, wherein a volume between said inner surface of said dielectically enclosing structure and said at least one probe line is at least partly filled by a solid dielectric filling material.

12. A radar level gauge system according to claim 11, wherein said solid dielectric filling material is selected from a group consisting of crystalline materials, amorphous materials, ceramic and glass.

13. A transmission line probe, for use in a radar level gauge system arranged to measure a filling level of a content contained in a tank, wherein said transmission line probe comprises:
at least one probe line configured to guide transmitted microwave energy towards and from said content; and
a dielectric structure essentially enclosing said probe line, wherein said enclosing structure is arranged to reduce the microwave energy attenuating effect caused by said content to be gauged.

14. A transmission line probe according to claim 13, wherein said transmission line probe comprises parallel probe lines, wherein at least a substantial part of said parallel probe lines are enclosed by said dielectric enclosing structure.

15. A transmission line probe according to claim 13, wherein said transmission line probe enclosed by said dielectric enclosing structure arranged in said tank is a Partially External Dielectric (PED) transmission line probe.

16. A transmission line probe according to claim 13, wherein said dielectric enclosing structure provides an insulation factor α which is greater than or equal to 0.2 and smaller than or equal to 0.8.

17. A transmission line probe according to claim 13, wherein said dielectric enclosing structure provides an insulation factor α which is greater than or equal to 0.2 and smaller than or equal to 0.5.

18. A transmission line probe according to claim 13, wherein said dielectric enclosing structure comprises an outer surface forming an outer surface of said transmission line probe, and an inner surface arranged at a distance from said at least one probe line.

19. A transmission line probe according to claim 13, wherein a distance (D) from an outer surface of said probe line with a dielectric enclosing structure to the outer surface of said probe line is greater than half a radius (R)) of said probe line.

20. A transmission line probe according to claim 13, wherein a distance (D) from the outer surface of said probe line with a dielectric enclosing structure to the outer surface of said probe line is greater than a radius (R) of said probe line.

21. A transmission line probe according to claim 13, wherein a distance (D) from the outer surface of said probe line with a dielectric enclosing structure to the outer surface of said probe line is greater than two times a radius (R) of said probe line.

22. A transmission line probe according to claim 18, wherein a volume between said inner surface of said enclosing structure and said at least one probe line is filled by a solid dielectric filling material.

23. A transmission line probe according to claim 18, wherein said solid dielectric filling material is selected from a group consisting of crystalline materials, amorphous materials, ceramic and glass.

101-123. (canceled)
